(19) United States
(12) Patent Application Publication
(10) Pub. No.: US 2006/0192987 A1
(43) Pub. Date: Aug. 31, 2006

(54) Bootable CD controller with embedded operating system

(76) Inventors: Vincent Wu, Irvine, CA (US); Sheng Lee, Irvine, CA (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/414,587

(22) Filed: Apr. 28, 2006

Related U.S. Application Data
(62) Division of application No. 10/156,521, filed on May 28, 2002.

(51) Int. Cl. G06F 3/12

(52) U.S. Cl. 358/1.13; 358/1.15

(57) ABSTRACT

A printer controller is disclosed which includes one or more non-volatile memory elements for storing print/fax/scan data and printer controller system parameters. The non-volatile memory elements can include flash memory PCMCIA cards. A non-volatile storage medium is also provided for retaining an operating system, wherein the printer controller is bootable from the non-volatile storage medium. The non-volatile storage medium is preferably a CD-ROM or other removable type data disc.

This application is a divisional of U.S. patent application Ser. No. 10/156,521, filed May 28, 2002.

### BACKGROUND OF THE INVENTION

The present invention is directed to the field of booting operating systems, particularly the type used for controllers of output peripheral components, such as network printers. The controllers of such network printers, e.g. models SC-2 and GL-1010, use the Microsoft Embedded NT operating system (OS). In order to perform these software updates, a controller CD-ROM is installed. The CD-ROM is used to boot up the system, after which the updates are made to the OS software on the controller hard drive. After the software update is completed, the user must remove the CD-ROM and reboot the controller from the hard drive. After the controller boots up and begins running, the controller accepts print jobs from a client. The controller can also network with the client to set up system and user parameters, and can store print/scan jobs on the controller hard drive.

In situations where software updates for operating systems can be frequent, the above steps of booting from the CD and rebooting from the hard drive can be cumbersome and time consuming. Also, additional time and effort may often be expended in diagnosing and troubleshooting OS problems after a software update. Also, the hard drive can be unreliable storage medium, vulnerable to computer viruses and other sources of errors or loss of data. Also, the hard drive is an additional component that adds to the size and expense of the controller.

### SUMMARY OF THE INVENTION

The difficulties and drawbacks associated with previous-type systems are overcome by the method and apparatus of the present invention. A printer controller is disclosed which includes one or more non-volatile memory elements for storing print/fax/scan data and printer controller system parameters. The non-volatile memory elements can include flash memory PCMCIA cards. A non-volatile storage medium is also provided for retaining an operating system, wherein the printer controller is bootable from the non-volatile storage medium. The non-volatile storage medium is preferably a CD-ROM or other removable type data disc.

As will be realized, the invention is capable of other and different embodiments and its several details are capable of modifications in various respects, all without departing from the invention. Accordingly, the drawing and description are to be regarded as illustrative and not restrictive.

### BRIEF DESCRIPTION OF THE DRAWINGS

FIG. 1 depicts a bootable CD controller in accordance with the present invention.

### DETAILED DESCRIPTION OF THE INVENTION

In order to simplify the two-step boot operation as mentioned above, the controller of the present invention uses OS and controller code from a non-volatile storage disc, preferably a CD-ROM or DVD-ROM. It utilizes external memory cards (non-volatile flash memory) to store user data and system parameters which would have been stored on hard drive. Since the static object code of the OS and controller resides on a different media than the variable user data and parameters, updating (or upgrading) the OS or Controller becomes extremely trivial. The administrator simply shuts down the system, replaces the CD with a new version, and restarts the system. The data and system parameters remain unchanged across system restart.

In the preferred embodiment, the present bootable CD controller uses an embedded operating system, preferably “Windows NT Embedded” sold by Microsoft Corporation. An embedded OS offers several benefits for this type of implementation. For example, this OS does not require the use of a keyboard, mouse or VGA monitor. Also, selectable modules can be installed on various destination media, including a hard drive, a ROM, and a CD-ROM. An embedded OS is reliable in system shutdown, reboot, and boot up states.

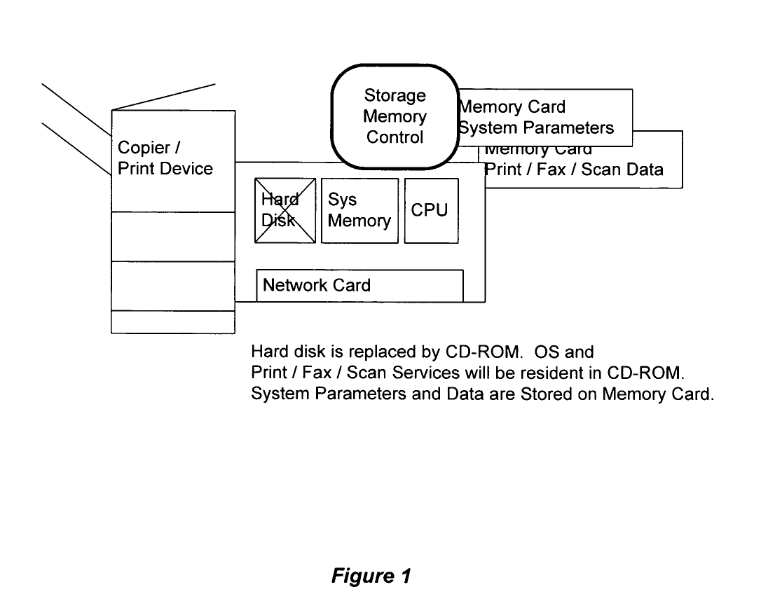

As shown in FIG. 1, a CD-ROM replaces the previous function of the hard drive, and the OS and system services remain with the CD-ROM, thus making it bootable. Storage for system parameters and print/fax/scan data is stored in Flash memory card. Two slots of PCMCIA cards are used, one for system, the other for data. Such data as had previously been stored on the hard drive is now retained in the memory card partitions.

The CD-ROM contains the bootable partition, the Windows NT Embedded Operating System files, the basic NT services, and the device drivers. The CD-ROM also contains the controller service files for “Print,” “Fax,” “Scan” and “Network” functions, along with web page files.

The system parameters are directed to the system memory card. This is preferably accomplished using the embedded OS tool called “Target Designer.” Of course, this can also be accomplished with other similar tools. The system memory card also includes a “Disable Page” file (i.e. a memory swap file) from the embedded OS and Windows NT activities settings (such as network setup parameters). The system memory card can retain other variable data such as a “Print Spooler” temporary file storage and system event logs.

The data is directed to the data memory card, and can include print job data. This print job data is in a file format that encompasses the function of the “job record” that had previously been stored in the NT registry. The data memory card also includes fax job data, scan data and email data, along with any job or message logs.

A “Storage Volume Control” utility program is preferably implemented to monitor memory card storage volume. This utility program includes software settings to limit the usage of partition, to prevent a maximum data limit to be exceeded.

As described herein, the present bootable CD controller provides many benefits, including the phase-out and discontinuation of the hard drive controller model, resulting in reducing the size of the hardware and the cost of distribution. Also, reliability of storage media is improved by replacing the volatile hard drive with a CD-ROM. The bootable CD also provides savings of time and effort for software version upgrades, and OS trouble shooting and diagnostics. The invention also provides virus protection by employing read-only media.

As described hereinabove, the present invention solves many problems associated with previous type systems. However, it will be appreciated that various changes in the details, materials and arrangements of parts which have been herein described and illustrated in order to explain the nature of the invention may be made by those skilled in the area within the principle and scope of the invention will be expressed in the appended claims.

We claim:

1. A method of provisioning software in a constrained memory document processor controller comprising the steps of:
removing, from an associated reader, a first read-only data storage medium including computer-readable instructions thereon, which computer readable instructions include,
boot instructions of a controller operating system for booting and operation of an associated document processing controller, and
instructions for implementing document processing functions on the controller, including at least one of printing, copying, scanning, storage, and facsimile transmission of electronic documents;
receiving, into the associated reader, a second read-only data storage medium including modified computer-readable instructions thereon, which modified computer readable instructions include at least one of,
a modified set of boot instructions of a controller operating system for booting and operation of an associated document processing controller, and
a modified set of instructions for implementing document processing functions on the controller, including at least one of printing, copying, scanning, storage, and facsimile transmission of electronic documents;
commencing a boot process of the associated document processing controller from the modified computer-readable instructions of the second read-only data storage medium for booting and operation of the document processing controller utilizing associated random access memory;
communicating at least one of user data and system parameters associated with the document processing controller between a volatile random access memory and a non-volatile random access memory after commencement of the boot process;
wherein the document processor controller operates from the modified computer-readable instructions loaded from the second read-only data storage medium and at least one of user data and system parameters communicated between the volatile random access memory and the non volatile random access memory.

2. The method of provisioning software in a constrained memory document processor controller of claim 1 wherein the first read-only data storage medium is at least one of a CD ROM, a DVD ROM, a read-only random access memory and a read-only flash memory.

3. The method of provisioning software in a constrained memory document processor of claim 1 wherein the second read-only data storage medium is at least one of a CD ROM, a DVD ROM, a read-only random access memory and a read-only flash memory and in medium unique from that of the first read-only data storage.

4. The method of provisioning software in a constrained memory document processor controller of claim 1 wherein the controller operating system contained on the first read-only data storage medium is an embedded operating system.

5. The method of provisioning software in a constrained memory document processor controller of claim 1 wherein the controller operating system contained on the second read-only data storage medium is an embedded operating system.

6. The method of provisioning software in a constrained memory document processor controller of claim 1 wherein the instructions for implementing document processing functions stored on the first read-only data storage medium includes at least one of print control data, fax control data, scan control data, job log data, message log data, user identification data, system configuration data and system event log data.

7. The method of provisioning software in a constrained memory document processor controller of claim 1 wherein the instructions for implementing document processing functions stored on the second read-only data storage medium includes at least one of print control data, fax control data, scan control data, job log data, message log data, user identification data, system configuration data and system event log data.

8. The method of provisioning software in a constrained memory document processor controller of claim 1 wherein the non-volatile random access memory includes data for monitoring amount of data stored thereon.

9. A system for provisioning software in a constrained memory document processor controller comprising:
reader means adapted for reading computer-readable instructions from an associated, read-only data storage;
means adapted for removing, from the reader means, a first read-only data storage medium including computer-readable instructions thereon, which computer readable instructions include,
boot instructions of a controller operating system for booting and operation of an associated document processing controller, and
instructions for implementing document processing functions on the controller, including at least one of printing, copying, scanning, storage, and facsimile transmission of electronic documents;
means adapted for receiving, into the associated reader, a second read-only data storage medium including modified computer-readable instructions thereon, which modified computer readable instructions include at least one of,
a modified set of boot instructions of a controller operating system for booting and operation of an associated document processing controller, and
a modified set of instructions for implementing document processing functions on the controller, including at least one of printing, copying, scanning, storage, and facsimile transmission of electronic documents;
commencing a boot process of the associated document processing controller from the modified computer-readable instructions of the second read-only data storage medium for booting and operation of the document processing controller utilizing associated random access memory;
communicating at least one of user data and system parameters associated with the document processing controller between a volatile random access memory and a non-volatile random access memory after commencement of the boot process;
wherein the document processor controller operates from the modified computer-readable instructions loaded from the second read-only data storage medium and at least one of user data and system parameters communicated between the volatile random access memory and the non volatile random access memory.

10. The system of provisioning software in a constrained memory document processor controller of claim 9 wherein the first read-only data storage medium is at least one of a CD ROM, a DVD ROM, a read-only random access memory and a read-only flash memory.

11. The system of provisioning software in a constrained memory document processor of claim 9 wherein the second read-only data storage medium is at least one of a CD ROM, a DVD ROM, a read-only random access memory and a read-only flash memory and in medium unique from that of the first read-only data storage.

12. The system of provisioning software in a constrained memory document processor controller of claim 2 wherein the controller operating system contained on the first read-only data storage medium is an embedded operating system.

13. The system of provisioning software in a constrained memory document processor controller of claim 9 wherein the controller operating system contained on the second read-only data storage medium is an embedded operating system.

14. The system of provisioning software in a constrained memory document processor controller of claim 9 wherein the instructions for implementing document processing functions stored on the first read-only data storage medium includes at least one of print control data, fax control data, scan control data, job log data, message log data, user identification data, system configuration data and system event log data.

15. The system of provisioning software in a constrained memory document processor controller of claim 9 wherein the instructions for implementing document processing functions stored on the second read-only data storage medium includes at least one of print control data, fax control data, scan control data, job log data, message log data, user identification data, system configuration data and system event log data.

16. The system of provisioning software in a constrained memory document processor controller of claim 9 wherein the non-volatile random access memory includes data for monitoring amount of data stored thereon.
